(19) United States
(12) Patent Application Publication
(10) Pub. No.: US 2026/0127766 A1
(43) Pub. Date: May 7, 2026

(54) COLOR AND SHADE DETECTION DEVICE AND METHOD

(71) Applicant: James R. Glidewell Dental Ceramics, Inc., Newport Beach, CA (US)

(72) Inventor: Kunal Patil, Foothill Ranch, CA (US)

(73) Assignee: James R. Glidewell Dental Ceramics, Inc., Newport Beach, CA (US)

(21) Appl. No.: 19/380,746

(22) Filed: Nov. 5, 2025

Related U.S. Application Data
(60) Provisional application No. 63/717,639, filed on Nov. 7, 2024.

(51) Int. Cl. G06T 7/90; G06T 17/00; G06V 10/143

(52) U.S. Cl. CPC G06T 7/90; G06T 17/00; G06V 10/143; G06T 2207/10024

(57) ABSTRACT

A device includes one or more homogenous telecentric illuminators, a 3D digital scanner arranged to scan the physical object and provide a 3D scan of the physical object, a 2D digital image detector arranged to generate a 2D digital image of the physical object and an object platform arm arranged to translate and rotate the physical object. Calibration includes determining a 3D digital scanner transform, a 2D digital image transform, and a color calibration matrix. A method includes receiving a 3D digital model of a physical object, arranging the physical object in a plane of detection of a 2D digital image detector, illuminating at least the pre-marked best color determination region with a unique light wavelength, taking a 2D digital image of at least the pre-marked best color determination region at the unique light wavelength, repeating illuminating and taking a 2D digital image for multiple unique light wavelengths, and determining a spectral response for each pixel in the 2D digital image.

### RELATED APPLICATIONS

The present application claims priority to and the benefit of co-pending U.S. Provisional Patent Application Ser. No. 63/717,639, entitled Color And Shade Detection Device And Method, filed on November 7, 2024, which is herein incorporated by reference in its entirety.

### BACKGROUND

Historically, physical objects such as dental restorations are checked for color and shade by human observations. One issue with the human observation approach is color and shade determination is subjective, not quantitative.

Spectrometers are typically not suited for measuring color and shade on uneven surfaces. Spectrometric measurement of uneven shiny or textured surfaces—such as those found on many physical objects, including dental restoration surfaces--can be very challenging. Moreover if the surface exhibits translucency behavior, the thickness of the surface can affect the reflectance. Even spectrophotometric devices that can measure the color of the surface of a physical object such as dental restorations do not accommodate for change in shade due to thickness of the walls of the physical object/dental restoration, which can change the translucency.

Measurements can also be affected due to the angle between the normal to the target surface and axis of the light from light source(s). Maintaining the sensor/camera axis parallel to the symmetry plane of the light source(s) can be challenging and time consuming, particularly in mass production environments. In the mass production environment, it can also be challenging to maintain the homogeneity of the light onto the target by keeping the distance between the object/ dental restoration surface and the light source constant.

Additionally, many devices available in the market do not account for fluorescence effects. Light Emitting Diode (“LED”) flux can change over time with respect to the temperature, which can have implications on the production floor, and requires calibration.

Finally, existing devices may not be adaptable for quality control (“QC”). Existing devices typically output the closest matching shade based on weighted distance approach, delta E difference from selected shade or raw lab color values. Full volumetric surface color measurement is not performed.

### SUMMARY

Disclosed is a device for detecting color and shade. The device can include one or more homogenous telecentric illuminators, a 3 dimensional scanner (3D digital scanner) arranged to scan the physical object and provide a 3D scan of the physical object, a 2D digital image detector arranged to generate a 2D digital image of the physical object and an object platform arm arranged to translate and rotate the physical object.

Also disclosed is a computer-implemented method of calibrating a device for color and shade detection. The method can include determining a 3D digital scanner to machine coordinate system transform, determining a 2D digital image detector to machine coordinate transform and determining a color calibration matrix.

Also disclosed is a computer-implemented method of determining color and shade. The method can include receiving a 3D digital model of a physical object comprising a pre-marked best color determination region, arranging the physical object so that the pre-marked best color determination region is in a plane of detection of a 2D digital image detector, illuminating at least the pre-marked best color determination region with a unique light wavelength, taking a 2D digital image of at least the pre-marked best color determination region at the unique light wavelength, repeating illuminating and taking a 2D digital image for multiple unique light wavelengths, and determining a spectral response for each pixel in the best color determination pixel region in the 2D digital image.

### BRIEF DESCRIPTION OF THE DRAWINGS

FIG. 1 is a perspective view showing the outside of a color and shade detection device in some embodiments.

FIG. 2 is a perspective view showing the inside of a color and shade detection device from a front side in some embodiments.

FIG. 3 is a perspective view showing the inside of a color and shade detection device from a back side in some embodiments.

FIG. 4 is an top orthogonal view of a diagram of the inside of a color and shade detection device in some embodiments.

FIG. 5 is a diagram of the inside of a light source in some embodiments.

FIG. 6 is a cross-sectional side view of an illustration of a bi-telecentric lens in some embodiments.

FIG. 7 is a table of wavelengths to absolute color mappings in some embodiments.

FIG. 8 is a top view diagram of a portion of the inside of a color and shade detection device configured for glossiness detection in some embodiments.

FIG. 9 is a flow diagram in some embodiments.

FIG. 10 is a diagram of a computing environment in some embodiments.

### DETAILED DESCRIPTION

For purposes of this description, certain aspects, advantages, and novel features of the embodiments of this disclosure are described herein. The disclosed methods, apparatus, and systems should not be construed as being limiting in any way. Instead, the present disclosure is directed toward all novel and nonobvious features and aspects of the various disclosed embodiments, alone and in various combinations and sub-combinations with one another. The methods, apparatus, and systems are not limited to any specific aspect or feature or combination thereof, nor do the disclosed embodiments require that any one or more specific advantages be present or problems be solved.

Although the operations of some of the disclosed embodiments are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods. Additionally, the description sometimes uses terms like “provide” or “achieve” to describe the disclosed methods. The actual operations that correspond to these terms may vary depending on the particular implementation and are readily discernible by one of ordinary skill in the art.

As used in this application and in the claims, the singular forms “a,” “an,” and “the” include the plural forms unless the context clearly dictates otherwise. Additionally, the term “includes” means “comprises.” Further, the terms “coupled” and “associated” generally mean electrically, electromagnetically, and/or physically (e.g., mechanically or chemically) coupled or linked and does not exclude the presence of intermediate elements between the coupled or associated items absent specific contrary language.

In some examples, values, procedures, or apparatus may be referred to as “lowest,” “best,” “minimum,” or the like. It will be appreciated that such descriptions are intended to indicate that a selection among many alternatives can be made, and such selections need not be better, smaller, or otherwise preferable to other selections.

In the following description, certain terms may be used such as “up,” “down,” “upper,” “lower,” “horizontal,” “vertical,” “left,” “right,” and the like. These terms are used, where applicable, to provide some clarity of description when dealing with relative relationships. But, these terms are not intended to imply absolute relationships, positions, and/or orientations. For example, with respect to an object, an “upper” surface can become a “lower” surface simply by turning the object over. Nevertheless, it is still the same object.

Some embodiments of the present disclosure can include a device for detecting color and shade. The device for detecting color and shade can include one or more homogenous telecentric illuminators. Each homogenous telecentric illuminator can include a light source. The light source can include one or more light emitters configured to emit light at a unique light wavelength. In some embodiments, the one or more light emitters within a particular light source emit light at a unique light wavelength.

In some embodiments, the light sources of the one or more homogenous telecentric illuminators can include the same number of light emitters. In some embodiments, a light emitter in one light source can have a corresponding/matching light emitter in another light source that emits light at the same light wavelength. The matching/corresponding light emitters among the light sources can be referred to as a corresponding set of light emitters. Each corresponding set of light emitters emit light at a particular light wavelength. In some embodiments, each light source can include seven light emitters.

In some embodiments, each light emitter is a Light Emitting Diode (LED). In some embodiments, each LED emits light at a particular light wavelength. In some embodiments, each of the light sources can include seven LEDs.

In an alternative embodiment, the one or more light sources can include tunable lasers known in the art. In yet another alternative embodiment, the one or more light sources can include a prism emitting a particular wavelength of light based on an input light surface.

Some embodiments can include a first light guide arranged to receive emitted light from a particular light source. In some embodiments, the first light guide can be a microlens. In some embodiments, the first light guide outputs diffused light. In some embodiments, the first light guide outputs homogenized light. The first light guide can be any type of light guide known in the art. One example of a light guide that can be used as the first light guide can be the Light Guide Rome 3,9- 7mm made of SUPRAX 8488 borosilicate glass having a length of 70 mm, an input aperture of 3.9 mm X 3.9 mm and an output aperture of 5.8 mm X 5.8 mm. Other light guides with suitable lengths and apertures can be used for the first light guide.

Some embodiments can include a light diffuser arranged to receive light from the first light guide and provide diffused light. The light diffuser can be part of the first light guide. Some embodiments can include a second light guide arranged to receive the diffused light and emit homogenous light. In some embodiments, the second light guide can be a microlens. In some embodiments, the second light guide can output further diffused light. In some embodiments, the second light guide can output further homogenized light. The second light guide can be any type of light guide known in the art. One example of a light guide that can be used as the second light guide can be the Techspec 5mm aperture, 60mm length Standard NA, Hexagonal Light Pipe from Edmund Optics. Other light guides with suitable lengths and apertures can be used for the second light guide.

Some embodiments can include a temperature detector arranged at each light source to determine each light source temperature. Some embodiments can include a cooling device arranged in cooling proximity each light source to cool each light source to a user-configurable value. In some embodiments, the cooling device can include a fan. In some embodiments, the cooling system channels cool air onto the one or more light sources to regulate a temperature of each light source. In some embodiments, the cooler air can include using air outside of an enclosure housing the one or more lights sources. In some embodiments, cooler air can include a venturi cooling system.

In some embodiments, the homogenous telecentric illuminator can include at least one light collimator for each light source to receive light and emit a beam of parallel light rays. In some embodiments, the light collimator receives the light emitted from the one or more light emitters of the light source of the homogenous telecentric illuminator. In some embodiments, the light collimator receives diffused and homogenized light. In some embodiments, the light collimator receives the emitted light after it passes through the first and second light guides and optionally one or more light filters and/or light diffusers. In some embodiments, the light collimator receives light of a particular wavelength at a particular time. In some embodiments, the light collimator can include a bi-telecentric lens to receive the emitted light from a corresponding light source and emit a beam of parallel light rays. In some embodiments, a first telecentric lens of the bi-telecentric lens receives light from its corresponding light source (or any light guides and/or diffusers between the first telecentric lens and its corresponding light source) and outputs a first beam of parallel light rays. In some embodiments, the light received from the corresponding light source is of a particular light emitter light wavelength, and the outputted first beam of parallel light rays is of the same particular wavelength as the light received. In some embodiments, the first telecentric lens can include a convergent telecentric lens. In some embodiments, a second telecentric lens of the bi-telecentric lens can include a beam expanding telecentric lens that receives the first beam of parallel light rays and outputs an expanded beam of parallel light rays. In some embodiments, the beam expanding telecentric lens outputs a beam of parallel light rays having a bigger output area than an input beam area. In some embodiments, the received light is of the particular wavelength emitted by the corresponding light source at a particular time. In some embodiments, the emitted beam of parallel light rays is of the same particular wavelength as the received light. In some embodiments, the received light is homogenous. In some embodiments, homogenized light has a consistent light intensity across the projected beam. In some embodiments, homogenized light has even light intensity in the center and the edges of the projected beam. One advantage of using light guides is producing homogenous light. One advantage of using bi-telecentric lenses in each homogenous telecentric illuminator is projecting a plane of light with equal intensity along the entire plane as output regardless of distance.

In some embodiments, each light source for its corresponding bi-telecentric lens can be moved or translated along its beam axis to focus the beam of parallel light rays. In some embodiments, each bi-telecentric lens has a gap with respect to an adjacent light guide. In some embodiments, the adjacent light guide can include the second light guide. In some embodiments, the bi-telecentric lens can be translated along its beam axis to adjust the focus length of the beam of parallel light rays.

In some embodiments, the one or more objects can include a dental restoration. In some embodiments, the dental restoration can include a crown, an inlay, a bridge, etc. In some embodiments, the dental restoration can include any dental restoration known in the art.

Some embodiments can include a polarizing lens to receive the beam of parallel light rays and provide polarized light having a first polarization. The first polarization can include p polarization.

Some embodiments can include a flux detector attached to each bi-telecentric lens to detect the flux emitted at each unique light emitter light wavelength. In some embodiments, the flux detector can be arranged to detect the flux of the polarized light. Alternatively, the flux detector can be arranged to detect the light flux of unpolarized light, in the case where a polarizing lens is not used. In some embodiments, the flux detector can be a photo diode.

In some embodiments, the device for detecting color and shade can include a 3 dimensional scanner (3D digital scanner) arranged to scan the physical object and provide a 3D scan of the physical object. 3D scanning can involve rotating the physical object. The computer-implemented method can issue a command through a programmable logic controller or other such device known in the art to rotate a rotatable platform and initiate scanning. In some embodiments, the 3D scanning can rotate the physical object 360 degrees.

In some embodiments, the device for detecting color and shade can include a 2D digital image detector to generate a 2D digital image of the physical object. In some embodiments, the image detector is arranged below the 3D digital scanner such that the physical object is in view of both the 2D digital image detector and the 3D digital scanner. The 2D digital image detector can receive reflected light from least a portion of the physical object. During operation, the at least portion of the physical object is typically a region of interest used for color and shade detection. The 2D digital image detector and the 3D digital scanner can be arranged so that the 3D digital scanner region of interest is in the field of view of the 2D digital image detector and the 3D digital scanner during 2D image detection and 3D scanning, respectively. The physical object can be rotated and/or translated as necessary so that the 3D digital scanner can scan the physical object and so that the 2D digital image detector can take a 2D image of region of interest.

In some embodiments, the 2D digital image detector can include a camera. In some embodiments, the image detector can include a monochrome camera, for example. The 2D digital image can include one or more pixels. Each pixel of the 2D digital image can represent the light intensity detected. Because the light emitted is of a particular wavelength at a particular point in time, the light intensity detected at each pixel is for the particular wavelength.

In some embodiments, the reflected light from the physical object can include P-polarized light and S-polarized light. Some embodiments can include an image detector polarizing lens arranged between the physical object and the image detector to filter out an undesired polarization state to provide a desired polarization state. In some embodiments, the undesired polarization state can S-polarized light, and the desired polarization state can include P-polarized light. In such a case, the image detector polarizing lens can filter out the S-polarized light and transmit P-polarized light onto the 2D image detected.

In some embodiments, the device for detecting color and shade can include an object platform arm that in combination with a rotatable object platform can translate and rotate a physical object in 3 dimensions (x,y,z) and around three axes. (A,B,C). The object platform arm with the rotatable object platform can rotate and translate so that the physical object can be 3D digitally scanned, and so that the region of interest can be arranged to face the 2D digital image detector during 2D image detection. In some embodiments, the region of interest can be arranged to face the 2D digital image detector during 2D image detection at a repeatable predefined distance. In some embodiments, the object platform arm and rotatable object platform can provide six degrees of motion.

In some embodiments, the physical object can include a dental restoration. For example, the dental restoration can include a crown, inlay, bridge, or any other dental restoration.

In some embodiments, the device for detecting color and shade can include one or more programmable logic controller(s) (PLCs). PLCs are known in the art, and can receive commands from a computer-implemented method to operate one or more components. PLC(s) can also receive status information from one or more devices to provide to the computer-implemented method.

In some embodiments, the device for detecting color and shade can include a color determining module to determine color of the physical object in the color determining region based on the 2D digital images. In some embodiments, the color determining module can be a software component that runs on a computer. The computer can include a processor and non-transient computer-readable medium that includes code to determine the color of the physical object. In some embodiments, the image detector is connected to the computing device(s). In some embodiments, the computing device(s) are part of the one or more detectors. In some embodiments, the computer with the color determining module is outside of an enclosure. In some embodiments, the color determining module can run in cloud software, or on a networked computer connected by wired or wireless communication with the device for color and shade detection.

In some embodiments, the device for detecting color and shade can include an enclosure to enclose one or more components/features described herein. For example, the enclosure can enclose the one or more homogenous telecentric illuminator(s), the 3D digital scanner, 2D digital image detector, and object platform. The enclosure can be made of a light-blocking material that prevents light outside of an enclosed region from entering the enclosed region during operation. In some embodiments, the enclosure is sized and shaped to accommodate the one or more objects. In some embodiments, the one or more objects can include a physical dental restoration. In some embodiments, the one or more objects can include any manufactured or natural object(s). In some embodiments, the manufactured object(s) is/are manufactured using an additive process. In some embodiments, the additive process is a 3D printer. In some embodiments, the manufactured object(s) is/are manufactured using any other process known in the art for manufacturing.

In some embodiments, the enclosure can include an access region to allow placing the one or more objects within the enclosure. The access region can be located outside of the main portion of the enclosure. The object platform can be translated so that it resides outside of the enclosure when an object is being loaded in the access region. The object platform can include an indented shape that can receive and lock in place a mounting that helps provide a fixed alignment for the object. Upon loading, a door or flap can open to allow the object to move from the outside access region into the enclosure. After the object is moved to inside the enclosure, the door or flap can be closed to minimize/block outside light from getting in. In some embodiments, the door or flap can be operated by an actuator connected to the PLC and can open and close upon receiving a command. The actuator can be mounted within the enclosure and connected to the door or flap to provide operation.

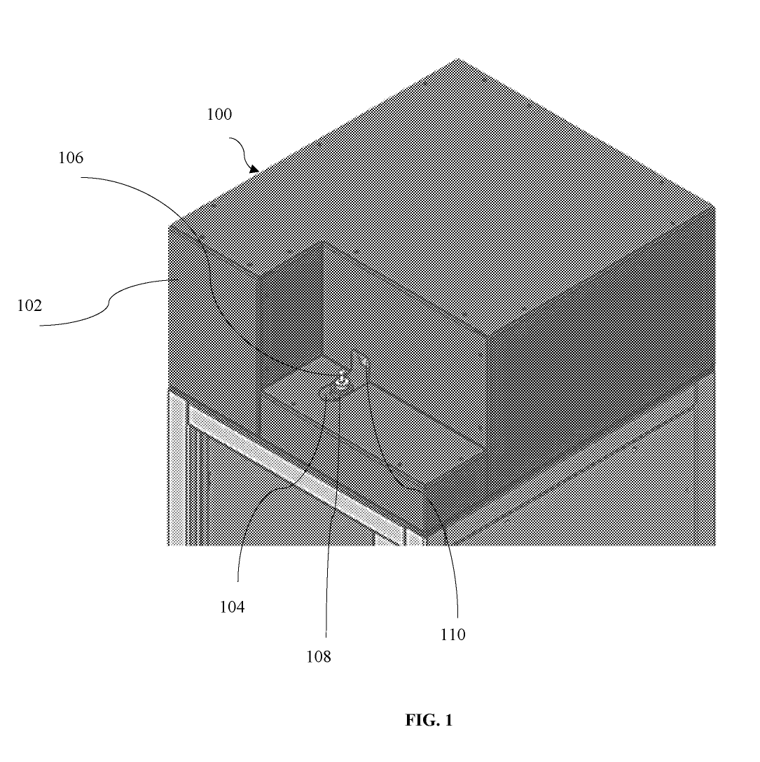

FIG. 1 illustrates the outside of a device for detecting color and shade 100 with an enclosure 102 in some embodiments. An access region 104 allows placement of a physical object 106 onto an object platform 108. The object platform 108 along the physical object 106 can be moved into the inside of the enclosure 102 through an automatically operated door 110. In some embodiments, the access region can be any suitable region allowing access to the interior of the enclosure 102. In some embodiments, the door 110 can be operated manually.

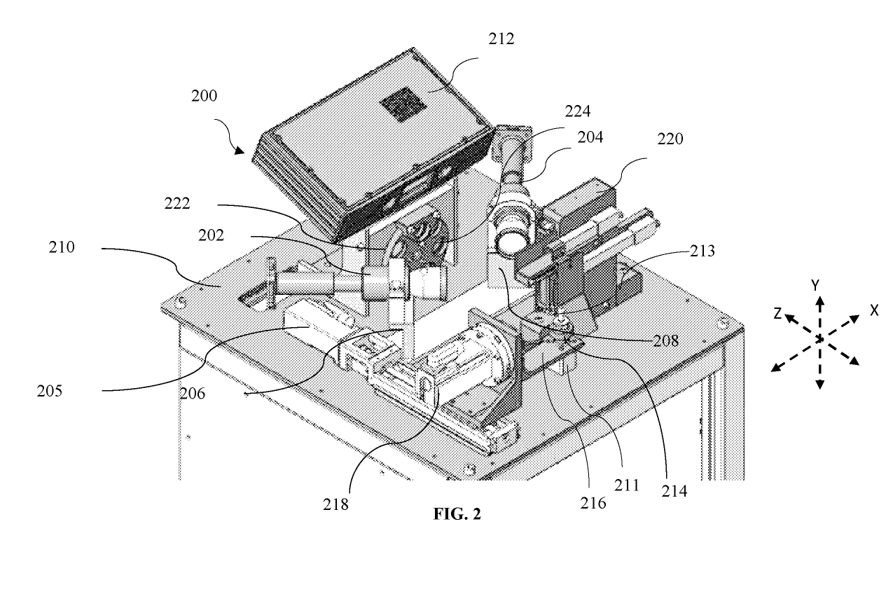

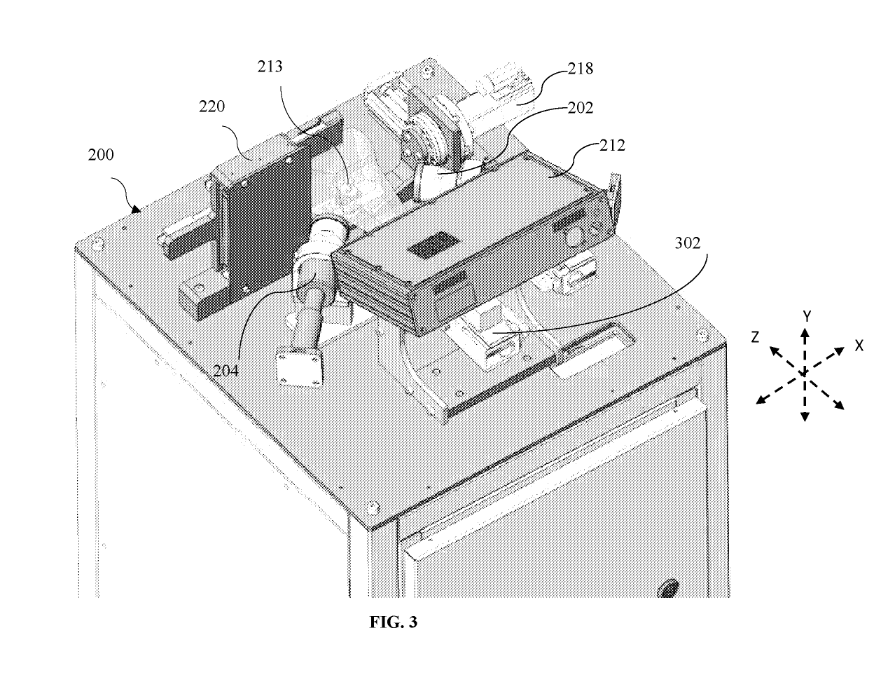

FIG. 2 illustrates a device for detecting color and shade 200 in some embodiments. One or more elements of the device 200 are enclosed by an enclosure that blocks out all or most light. The enclosure is not shown in order to illustrate the elements of the device 200. The device can include a first homogenous telecentric illuminator 202 and a second homogenous telecentric illuminator 204 each affixed by their respective fixture 206 and fixture 208 to a base 210 of the device. The device can also include a 3D digital scanner 212 affixed to the base 210 to 3D digitally scan a physical object 213 that is placed on an object platform 214, which is arranged on an object platform arm 216. The object platform 214 can rotate around the Y-axis using motor 211. The object platform arm 216 can be connected to a motor 205 that can translate the object platform arm 216 and object platform 214 along the Z-axis. The object platform arm can also be connected to a motor 218, which can rotate the object platform arm 216 and object platform 214 around the X-axis. The object platform arm 216 can be translated and rotated by any suitable amount along with the physical object 213 so that one or more features can be performed in the present disclosure, such as 3D scanning by the 3D digital scanner 212 and 2D image detection by a 2D digital image detector 302 shown in FIG. 3, as well as moving the physical object 213 in and out of the enclosure, and adjusting the physical object 213 so that a best color determination region can be scanned by the 3D digital scanner 212 and imaged by a 2D digital image detector. In some embodiments, the object platform arm 216 can be rotated and translated to cover a 20 mm cube volume area for some physical objects, such as dental restorations. However, a greater or smaller cubic volume articulation can be used for larger or smaller objects in some embodiments, and the disclosure is not limited to any particular cubic volume. In some embodiments, at least suitable amount of translation can be used to load the physical object 213 from outside of the enclosure to within the enclosure, along with an additional amount of translation for movement within the enclosure. As an example, in some embodiments, the object platform arm 216 can translate 50 mm to move the physical object 213 from outside the enclosure to inside the enclosure, with an additional 20 mm for internal translation, and therefore provide about 80 mm of translation in some embodiments, for example. In some embodiments the object platform arm 216 can provide any suitable amount of translation required. In some embodiments, the object platform arm 216 can be rotated by an angle suitable for one or more features described in the present disclosure. In some embodiments, the object platform arm 216 can be rotated +/- 30 degrees around the x-axis. However, any suitable amount of rotation can be provided to 3D scan and take a 2D digital image of at least a portion of the physical object 213. The device can also include a door actuator 220 that can open and close a door that provides access to the inside of the device 200 so that the object 213 can be moved within the enclosure.

In an alternative embodiment, the device 200 can additionally include an optional light filtering wheel 222 that can include one or more light wavelength filters, such as light wavelength filter 224. The light filtering wheel 222 can be arranged to rotate around the Z-axis. In some embodiments, the light filtering wheel 222 is not present. As shown in FIG. 3, the device 200 can also include a 2D digital image detector 302 for detecting color and shade. The 2D digital image detector 302 can receive light reflected from the physical object 213 to record a 2D digital image of the physical object 213.

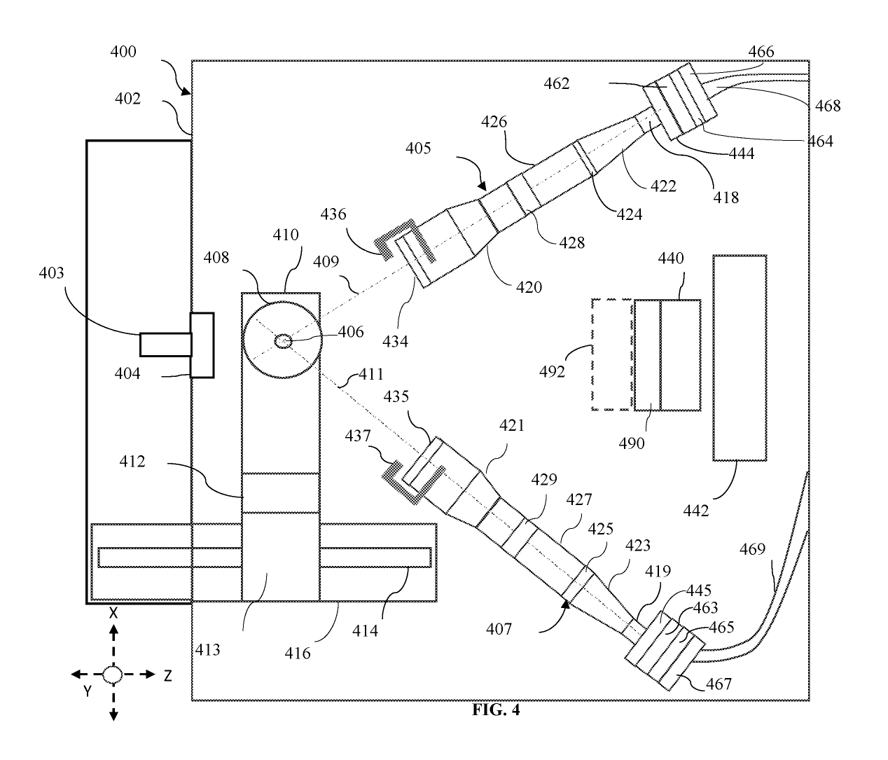

FIG. 4 illustrates a device for detecting color and shade 400 in some embodiments. In some embodiments, one or more elements can be enclosed by enclosure 402 which has a door 404 and an access region 403 to provide accessibility to the inside of the enclosure 402. The enclosure 402 can block out all or a majority of external light.

In some embodiments, the device 400 can include a first homogenous telecentric illuminator 405 and a second homogenous telecentric illuminator 407. The first homogenous telecentric illuminator 405 and the second homogenous telecentric illuminator 407 can be arranged such that a first homogenous telecentric illuminator beam axis 409 and a second homogenous telecentric illuminator beam axis 411 intersect onto an object platform 408 to illuminate at least part of a physical object 406 during 3D digital scanning by a 3D digital scanner 442 and a 2D digital image detector 440 at a scanning position. In some embodiments, the first homogenous telecentric illuminator beam axis 409 and the second homogenous telecentric illuminator beam axis 411 can be at 45 degrees with respect to the Z-axis. The object platform 408 can be circular and attached to a motor that is in communication with the PLC and can rotate the object platform 360 degrees around the Y axis. The object platform 408 can be arranged on an object platform arm 410. The object platform arm 410 can be attached to, extend from, and be rotated by rotating gear 412 around the X-axis. The rotating gear 412 and the object platform arm 410 to which it is connected can be moved (translated) along the Z-axis by a motor along a translation channel 416. The translation channel 416 can include a translation channel rod 414 to guide movement of the object platform arm 410, object platform 408, and rotating gear 412 along the Z-axis. The rotating gear 412, the object platform arm 412 and the object platform 408 rotatable gear/center spindle are conventional parts known it the art. The motor 413 to rotate the rotating gear 412 and thus the object platform arm 410, the motor to move the object platform arm 410 along the Z-axis, and the motor to rotate the object platform 408 can be connected to the PLC so that a computer-implemented method can provide commands to move the object platform arm 410 (along with the object platform 408, and the rotating gear 412) along the Z-axis, and rotate the object platform arm 410 around the X-axis, as well as rotate the object platform 408 around the Y-axis.

One or more motors, actuators, sensors, imaging and scanning devices can be connected to a PLC that communicates with the computer-implemented method in some embodiments.

In some embodiments, the first homogenous telecentric illuminator 405 can include a first light source 418 with a light source base 444. The light source base 444 and/or first light source 418 can communicate with the PLC to send and receive commands and data and therefore be controlled by a computer-implemented method that also communicates with the PLC. The light source base 418 can be connected to a temperature sensor 462 that can also communicate with the PLC to send and receive commands and data, or directly with a computer-implemented method to provide light emitter/light source temperature. The temperature sensor 462 can be connected to a thermal conduction region 464 dimensioned to provide maximum contact with the first light source base 444. The thermal conduction region 464 can be connected to a cooling region 466. The cooling region 466 can transmit cool air and/or liquid from a tube 468, which can be connected to a cooling system such as a fan, venturi, or other cooling systems known in the art. The cooling system can be internal or external to the enclosure 402. Cool air/liquid can thus be provided to the cooling region 466 as necessary and conducted via thermal conduction region 464 to the light emitter base 444 and the first light source 418.

The first light source 418 can also connect to a light guide 422 to direct light from the first light source 418 to a light diffuser/filter 424. The light diffuser/filter 424 can provide homogenized light to a light guide 426 that emits light through an adjustment/focus region 428 to a bi-telecentric lens 420. The homogenous telecentric illuminator 405 can also include a polarizing lens 434 to polarize light exiting the bi-telecentric lens 420. In some embodiments, the polarizing lens 434 can transmit P-polarized light and block S-polarized light. In some embodiments, a flux detector 436 can be affixed to the bi-telecentric lens to measure the amount of light exiting the bi-telecentric lens. The flux detector 436 can be in communication with the PLC and/or a computer-implemented method directly to provide the amount of exiting light in some embodiments.

In some embodiments, the second homogenous telecentric illuminator 407 can include a second light source 419 with a light source base 445. The light source base 445 and/or second light source 419 can communicate with the PLC to send and receive commands and data and therefore be controlled by a computer-implemented method that also communicates with the PLC. The light source base 445 can be connected to a temperature sensor 463 that can also communicate with the PLC to send and receive commands and data, or directly with a computer-implemented method to provide light emitter/light source temperature. The temperature sensor 463 can be connected to a thermal conduction region 465 dimensioned to provide maximum contact with the light source base 445. The thermal conduction region 465 can be connected to a cooling region 467. The cooling region 467 can transmit cool air and/or liquid from a tube 469, which can be connected to a cooling system such as a fan, venturi, or other cooling systems known in the art. The cooling system can be internal or external to the enclosure 402. Cool air/liquid can thus be provided to the cooling region 467 as necessary and conducted via thermal conduction region 465 to the light emitter base 445 and the second light source 419 to cool the emitters to an operation temperature.

The second light source 419 can also connect to a light guide 423 to direct light from the second light source 419 to a light diffuser/filter 425. The light diffuser/filter 425 can provide homogenized light to a light guide 427 that emits light through an adjustment/focus region 429 to a bi-telecentric lens 421. The homogenous telecentric illuminator 405 can also include a polarizing lens 435 to polarize light exiting the bi-telecentric lens 421. In some embodiments, the polarizing lens 435 can transmit P-polarized light and block S-polarized light. In some embodiments, a flux detector 437 can be affixed to the bi-telecentric lens 421 to measure the amount of light exiting the bi-telecentric lens 421. The flux detector 437 can be in communication with the PLC and/or a computer-implemented method directly to provide the amount of exiting light in some embodiments.

In some embodiments, the device 400 can include a 2D digital image detector 440 arranged to receive reflected light from the physical object 406 during 2D digital image detection. In some embodiments, an optional polarizing lens 490 can be arranged first transmit light of a particular polarization prior to image detection. In some embodiments, the light of the particular polarization can be P-polarized light, which can be transmitted to the 2D digital image detector 440, while S-polarized light can be blocked or filtered out by the polarizing lens 490.

In some embodiments, the device 400 can include a 3D digital scanner 442 which can be used to generate a 3D digital scan of the physical object 406 during operation.

In some embodiments, the first light source 418 can include one or more light emitters, each emitting light at a particular light wavelength. In some embodiments, the light emitters can be individual LEDs, each emitting light at a particular light wavelength. For example, the first light source 418 can include seven light emitters, a1, a2, a3, a4, a5, a6, a7 arranged within the first light source 418. However, the number of light emitters can be more or less than seven, and the light emitted wavelengths can be any suitable wavelengths.

In some embodiments, the second light source 419 can include one or more light emitters, each emitting light at a particular light wavelength. In some embodiments, the light emitters can be individual LEDs, each emitting light at a particular light wavelength. For example, the first light source 419 can include seven light emitters, b1, b2, b3, b4, b5, b6, b7 arranged within the first light source 418.

In some embodiments, any number of LEDs can be used. In some embodiments, a light source known in the art such as LED ENGIN (LZ7-04M2PD) from Osram Opto Semiconductors as part of the LuxiGen Multi-Color Emitter Series can be used. Other commercially known multi-wavelength emitting light sources can be used. The light source can include a red emitter A emitting minimum dominant wavelength of 620nm and maximum dominant wavelength of 624nm, a red emitter B emitting a dominant minimum wavelength of 624nm and a dominant maximum wavelength of 628nm, include a green emitter A emitting minimum dominant wavelength of 519nm and maximum dominant wavelength of 522nm, a green emitter B emitting a dominant minimum wavelength of 522nm and a dominant maximum dominant wavelength of 525nm, a blue emitter A emitting minimum dominant wavelength of 449nm and maximum dominant wavelength of 453nm, and a cyan emitter A emitting a dominant minimum wavelength of 495nmnm and a dominant maximum dominant wavelength of 502nm. However, other wavelengths can be used.

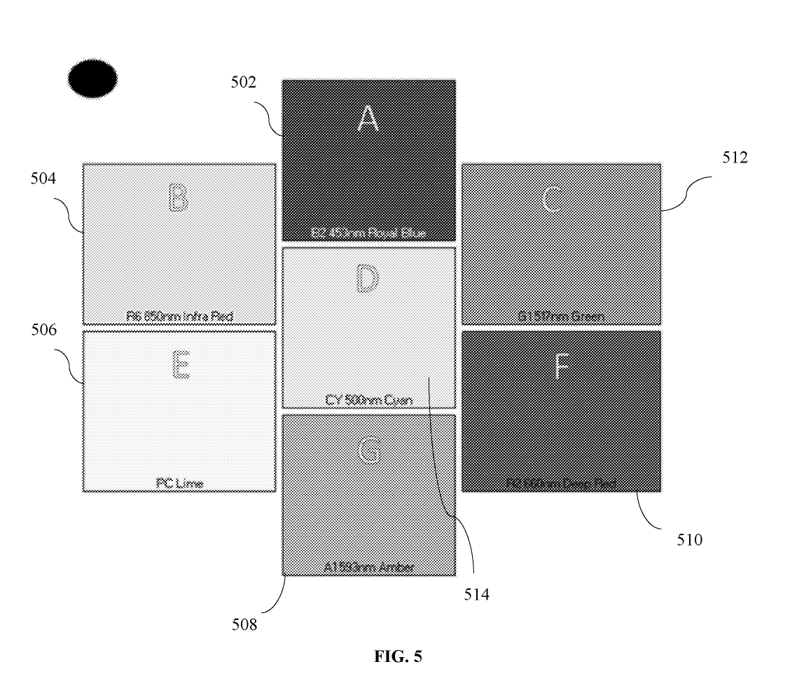

In an alternative embodiment, a custom multi-wavelength emitting light source can be used. In addition to emitting light in the visible spectrum, the custom light source can also emit light in the infrared spectrum. For example, a light source can include a die that emits light at 850nm, or other suitable wavelength for glossiness detection. One example of a light source can include the LED ENGIN LuxiGen (LQ7-04MZPD-0817) from Osram Opto Semiconductors. FIG. 5 illustrates a layout of emitters in a customized light source in some embodiments. The light emitters can include a 453nm wavelength royal blue light emitter 502, a 850nm wavelength infra red light emitter 504, a PC Lime light emitter 506, a 593nm wavelength amber light emitter 508, a 660nm wavelength deep red light emitter 510, a 517nm wavelength green light emitter 512, and a 500nm wavelength cyan light emitter 514 as an example. However, other arrangements and wavelengths can be used.

In some embodiments, each light emitter in a light source can have a corresponding light emitter in the other light source. For examples, light emitters in light source 418 can have corresponding light emitters in light source 419. The corresponding light emitters can emit light at the same light wavelength. For example, light emitters a1 and b1 can both emit light at the same light wavelength and be a corresponding set of light emitters, light emitters a2 and b2 can both emit light at the same light wavelength and be a corresponding set of light emitters, light emitters a3 and b3 can both emit light at the same light wavelength and be a corresponding set of light emitters, light emitters a4 and b4 can both emit light at the same light wavelength and be a corresponding set of light emitters, light emitters a5 and b5 can both emit light at the same light wavelength and be a corresponding set of light emitters, light emitters a6 and b6 can both emit light at the same light wavelength and be a corresponding set of light emitters, and light emitters a7 and b7 can both emit light at the same light wavelength and be a corresponding set of light emitters. As discussed previously, the number of light emitters and their wavelengths can vary.

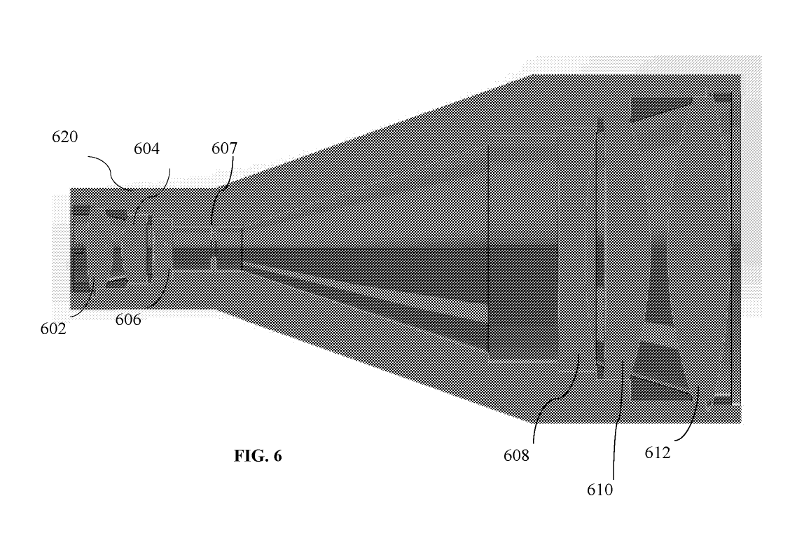

FIG. 6 illustrates a cross-sectional view of a bi-telecentric lens in some embodiments. The bi-telecentric lens can include a first convex lens 602 that receives input homogenized light from a light guide, for example, and transmits the homogenized light to a second convex lens 604. The second convex lens 604 transmits the light to a first concave lens 606. The light from the first concave lens 606 is passed through aperture 607 and onto a second concave lens 608. The second concave lens 608 transmits the light onto a third convex lens 610, which then transmits light onto a fourth convex lens 612. In some embodiments, the first convex lens 602 can have an aperture of 9.2mm, the second convex lens 604 can have an aperture 8mm, the first concave lens 606 can have an aperture 7mm, the second concave lens 608 can have an aperture of 28mm, the third convex lens 610 can have an aperture of 30mm, the fourth convex lens 612 can have an aperture of 35mm. The aperture 608 can have an aperture diameter that is suitable for the amount of telecentricity needed. In some embodiments, the bi-telecentric lens can include a casing 620.

In an alternative embodiment, turning back to FIG. 4, light source 418 and light source 419 can emit white light, or light containing multiple light wavelengths. In such an embodiment, a light filtering wheel 492 can be arranged between the physical object 406 and the 2D digital image detector 440 (through optional polarizing lens 490). The light filtering wheel 492 can receive reflected light from the physical object 406 (through the optional polarizing lens 490). The reflected light can contain multiple light wavelengths. The light filtering wheel 492 can include multiple light filters at different rotational positions around the Z-axis. The light filtering wheel 492 at a particular rotational position can filter the reflected light and only transmit a particular filtered wavelength of light to the 2D digital image detector 440 (through optional polarizing lens 490). The computer-implemented method can through the PLC command the 2D digital image detector to take a 2D digital image at the particular filtered light wavelength. After a 2D digital image is taken at the particular filtered light wavelength, the computer-implemented method can through the PLC command the light filtering wheel 492 to rotate to the next rotational position, which contains a different light filter to transmit light of a different particular light wavelength. The computer-implemented method can through the PLC command the 2D digital image detector to take a 2D digital image at the next position of the light filtering wheel 492. This process can be repeated until the desired number of 2D digital image is taken at the desired wavelengths. In some embodiments, this can include all of the rotational positions of the light filtering wheel 492. In some embodiments, the number of filters and rotational positions of the light filtering wheel 492 can be seven. However, any suitable number of filters and therefore rotational positions can be used.

Some embodiments can provide a computer-implemented method of calibrating a device for color and shade detection. The computer-implemented method of calibrating the device can include a computer-implemented method of performing a base device calibration. The base device calibration can be performed prior to operating the device for the first time. The base device calibration can also be performed periodically as necessary, such as if/when components of the device are adjusted, changed, or the device is moved, or environmental conditions change, for example.

In some embodiments, the base device calibration method can include a computer-implemented method for determining a 3D digital scanner to machine coordinate system transform. The 3D digital scanner to machine coordinate system transform can translate the coordinate system of the 3D digital scanner into the machine/device/scanning environment coordinates (and vice versa) of the color and shade detection device, in particular, the machine coordinates of the object platform. Accordingly, the 3D digital scanner to machine coordinate system transform can include calibrating the 3D digital scanner to determine a coordinate system transform matrix for the 3D digital scanner and the machine/device/scanning environment, such as the object platform. In some embodiments, the 3D digital scanner to machine coordinate system transform can be determined by first loading a physical sphere of known dimensions (such as a known diameter or radius) onto the object platform in the access region. Once the physical sphere is loaded onto the object platform, the computer implemented method can open the access door and translate (move) the object platform into the enclosure to a scanning position within scanning range of the 3D digital scanner. The scanning position can be a user-configurable location stored and used to perform 3D digital scans in some embodiments. Once the physical sphere is inside the enclosure, the computer-implemented method can close the door/flap. Next, the computer-implemented method can instruct 3D digital scanner to 3D scan the physical sphere at different locations to provide multiple 3D sphere scans.

In some embodiments of the 3D digital scanner to machine coordinate system transform, the computer-implemented method can determine an X-axis and an Y-axis. To determine the X-axis, the computer-implemented method can, using the loaded extended physical sphere, rotate the object platform arm around the X-axis to a first position, take a first position 3D digital scan at the first position, rotate the object platform to a second pre-defined position around the X-axis, take a second position 3D digital scan at the second pre-defined position, rotate the object platform to a third pre-defined position around the X-axis, and take a third position 3D digital scan at the third pre-defined position. The computer-implemented method can fit a sphere at a first position 3D digital scan to get the first position center of the sphere at that position, fit a sphere at the second position 3D digital scan to get the second position center of the sphere at that position, and fit a sphere at the third position 3D digital scan to get the third position center of the sphere at that position. The first, second, and third position centers form a plane. The computer-implemented can fit a circle connecting the first, second, and third position centers. From the fitted circle, the computer-implemented method can determine a center of the circle. The computer-implemented method can determine X-vector through the center of the circle and perpendicular to the plane.

To determine the Y-axis, the computer-implemented method can, using the loaded extended physical sphere, rotate the object platform arm around the Y-axis to a first position, take a first position 3D digital scan at the first position, rotate the object platform to a second pre-defined position around the Y-axis, take a second position 3D digital scan at the second pre-defined position, rotate the object platform to a third pre-defined position around the Y-axis, and take a third position 3D digital scan at the third pre-defined position. The computer-implemented method can fit a sphere at a first position 3D digital scan to get the first position center of the sphere at that position, fit a sphere at the second position 3D digital scan to get the second position center of the sphere at that position, and fit a sphere at the third position 3D digital scan to get the third position center of the sphere at that position. The first, second, and third position centers form a plane. The computer-implemented can fit a circle connecting the first, second, and third position centers. From the fitted circle, the computer-implemented method can determine a center of the circle. The computer-implemented method can determine Y-vector through the center of the circle and perpendicular to the plane.

In some embodiments, an intersection of the X and Y vectors forms the origin of the machine coordinate system in the 3D scanner coordinate system. This provides the transform. Using the right-hand rule, the computer-implemented method can determine a Z-vector.

Furthermore, to find the complete transformation, two scans of the physical sphere are taken along the Z-axis by moving the physical sphere from the origin to a unit distance (e.g. 1mm). In some embodiments, the computer-implemented method converts the vectors of the coordinate system in to unit vectors. These unit vectors represent the transformation from the 3D digital scanner coordinate system to the machine coordinate system.

In some embodiments, the coordinate system can be moved or translated along the Z-axis to coincide with the location where the color calibration tile 2D digital images will be taken. In some embodiments, this can be determined by first 3D digital scanning a white tile. The white tile can be loaded onto the object platform and to an imaging position along the Z-axis. The imaging position can be where the telecentric beams of light from the first homogenous telecentric illuminator and the second homogenous telecentric illuminator converge. This can be determined manually by a user during calibration with the enclosure of the scanning device removed. The imaging position is then recorded by the computer-implemented method. The offset between the coordinate system and the imaging position is measured and stored by the computer-implemented method so that the device can move the physical objects to offset position during operation.

Some embodiments of the base calibration method can include determining a 2D digital image detector to machine coordinate transform. In some embodiments, a tile with a checkerboard pattern can be loaded and imaged at different positions and the camera can be calibrated from the images as is known in the art. Other techniques for camera calibration known in the art can be used.

In some embodiments, the 2D digital image detector to machine coordinate transform can be determined by 3D digitally scanning the physical sphere by moving the object platform arm so that the physical sphere along the Z-axis is at the imaging position and taking a 2D digital image. In the 2D digital image, the sphere can appear as a circle. The computer-implemented method can determine a center of the circle in the 2D digital image. The computer-implemented method can determine a radius in pixels from the center of the circle. The computer-implemented method can determine the number of pixels to the real-world distance.

The computer-implemented method can then command the motor through the PLC to move the object platform arm along the Z-axis toward the 2D digital image detector by a known unit distance (e.g. 1mm). The computer-implemented method can then take a second 2D digital image using the 2D digital image detector, determine the 2D digital image circle center, and determine the radius in pixels of the second 2D digital image circle. This provides the center of sphere in the 2D digital image detector coordinate system. Since a 3D digital scan was taken of the same sphere at the same location, the computer-implemented method has the x,y,z position of the sphere in machine coordinate system. From this, the transform between the machine coordinate system and the 2D digital image detector coordinate system can be found.

The computer-implemented method can thus determine relationship or scaling factor (perspective correction) between pixels and units of machine movement along the Z-axis (e.g. how many pixels are in 1mm). The computer-implemented method can determine a 2D digital image tilt by taking a first 2D digital image of the physical sphere at a first rotational position around the Y-axis, rotating the physical sphere around the y axis by 180 degrees and taking a second 2D digital image of the physical sphere at a second rotational position around the Y-axis, find centers of two the circles, connect a line through the centers. The angle between the line and a horizontal line from the central pixel of the 2D digital image can be determined by the computer-implemented method as the tilt. The computer-implemented method can then correct for the tilt for each 2D digital image taken during operation.

Some embodiments of the base calibration method can include determining a camera calibration matrix (“CCM”). In some embodiments, the CCM can be determined using one or more certified color calibration tiles known in the art. One example of color tiles can be those provided by Lucideon. Certified color calibration tiles can be those whose spectral response is measured and certified by a laboratory which itself is certified to be compliant with the International Commission on Illumination (“CIE”) standard, for example, and provided as a certified spectral response report. The spectral response can be referred to as the reflectance or amount of light reflected from the particular tile at a particular light wavelength. The spectral response can be measured in percentage or as a value between 0 and 1, with 0 being no reflection, and 1 being maximum reflection. The reflection can be recorded by a detector as a light intensity value in some embodiments. Each certified color tile’s spectral response can be referred to as the certified spectral response.

In some embodiments, the spectral response for each certified color tile can be for light wavelengths from a starting calibration wavelength to a final calibration wavelength taken at a calibration wavelength interval by the certifying institution. For example, in some embodiments, the starting calibration wavelength can be 380nm and the final calibration wavelength can be 750nm (visible spectrum) at a calibration wavelength interval of 5nm. In such an example, a laboratory or other certification institution such as the International Commission on Illumination (“CIE”) can measure each tile’s spectral response starting at 380nm and at every 5nm until reaching 750nm. In some embodiments, the calibration wavelength interval can be 1 nm, or 2 nm, or 10 nm, or other suitable value. Thus, the certified spectral response for the specific tiles to be used for color calibration can be obtained. Other starting calibration wavelengths, final calibration wavelengths, and calibration wavelength intervals can be used, and the disclosure is not limited to the visual spectrum or to a particular calibration wavelength interval.

During CCM calibration, a certified color calibration tile is loaded onto the object platform in the access region. CCM calibration can be initiated by using a graphical user interface (“GUI”) button or can be automatically initiated. The computer-implemented method can signal the PLC to use actuators and motors after a tile is placed on the object platform to perform the following operations: open the door/flap, move the object platform with the tile into the enclosure at the imaging position, close the door, activate all light emitters in each homogenous telecentric illuminator to bring the light emitters to an operating temperature, record the operating temperature, deactivate all light emitters, activate a corresponding set of light emitters at a particular light wavelength and take and store a 2D digital image at the particular light wavelength, then deactivate the corresponding set of light emitters, then repeat for all the corresponding set of light emitters at various wavelengths. After a 2D digital image has been taken at all corresponding sets of light emitters take and store a 2D digital image as a dark noise image (with all light emitters deactivated). This assumes that the exposure and sensor sensitivity of the 2D digital image detector are kept constant. The process can be repeated for each tile. In some embodiments, the number of tiles can be twelve tiles. In some embodiments, an additional white tile can also be similarly imaged at each particular light emitter light wavelength and recorded as a base-line white tile 2D digital image.

In some embodiments, the computer-implemented can determine the CCM (also known as camera matrix or color transform matrix) using the certified color calibration tiles. In some embodiments, twelve certified color calibration tiles can be used. In some embodiments, more or fewer certified color calibration tiles can be used. During CCM calibration, the computer-implemented method takes a 2D digital image of each certified tile at each particular light emitter light wavelength to generate a recorded tile pixel value at each pixel for each particular light emitter light wavelength.

In an alternative embodiment, the light source for each homogenous telecentric illuminator emits white light, and the filter wheel passes light of a particular unique wavelength at each rotational position of the filter wheel. A 2D digital image of each certified color calibration tile is thus recorded at each rotational position corresponding to a particular unique wavelength by rotating the filter wheel.

The recorded tile pixel value represents the intensity of light detected at the particular light wavelength at the particular pixel. The intensity of light detected can also be referred to as a reflectance of the particular wavelength light by the particular tile for a particular pixel. Accordingly, the recorded tile pixel value can be the amount of reflectance by the tile at that particular light wavelength. In the example of seven light wavelengths, each certified color calibration tile can have seven 2D digital images, so that each pixel has seven reflectance or intensity values, one for each light emitter wavelength.

In some embodiments, the computer-implemented can eliminate dark noise by subtracting the values of pixels in 2D digital dark noise image from each 2D digital image taken at the different light emitter wavelengths.

In some embodiments, the computer-implemented method can determine the CCM via linear regression based on the 2D digital images and the certified spectral response of each color tile provided in the certified spectral response report of the color calibration tiles. For example, in some embodiments, the computer-implemented method can perform linear regression to solve for CCM. In some embodiments, the certified spectral response can be referred to as a Target Matrix, T, and the recorded tile pixel values for each light emitter light wavelength (or filtered wavelength) as a matrix S (average of n number of pixels in a user-selectable region—such as a center region). The computer implemented method can determine A=T*S_transpose and B=[S*S_transpose]^-1. The computer-implemented method can then determine CCM=A*B.

In some embodiments, the computer-implemented method can include calibration for gloss determination. In some embodiments, due to cross-polarization of one or more polarizing filters, glossiness cannot be measured in the visible spectrum range since glossiness relies on S-polarized light, which is filtered out by the polarizers. In some embodiments, the polarizers only polarize light up to a maximum polarizing wavelength. For example, in some embodiments, polarizers stop polarizing light at the maximum polarizing wavelength of 750nm. Wavelengths above the maximum polarizing wavelength are not polarized. Accordingly, wavelengths above the maximum polarizing wavelength are typically transmitted by the polarizer in both the P-polarized state and the S-polarized state. In some embodiments, the computer-implemented method can determine glossiness of the physical object based on the S-polarized state. Accordingly, in some embodiments, the computer-implemented method can utilize a light emitter in one or more light sources to emit a polarizer bypassing wavelength which is greater than the maximum polarizing wavelength.

In some embodiments, gloss calibration can utilize a certified gloss calibration tile or other certified gloss calibration object certified to be with a known gloss reflectivity to determine a base glossiness. The certified gloss calibration tile/object can loaded onto the object platform, and the computer-implemented method can command the object platform arm to move the certified gloss calibration tile/object to within the enclosure and close the door to block out external light from the inside of the enclosure. In some embodiments, the computer-implemented method can determine the base glossiness by turning off the light sources in a first homogenous telecentric illuminator and commanding the object platform to rotate the certified gloss calibration tile/object by any degree that reflects S-polarized light into the 2D image detector. In some embodiments, the computer-implemented method rotates the certified gloss calibration tile/object on the rotatable object platform and rotates the object platform arm such that an angle between a normal to the certified gloss calibration tile/object surface and second homogenous telecentric illuminator is the same as the angle between the normal to the certified gloss calibration tile/object surface and the 2D digital image detector. In some embodiments, the degree can be 12.5 degrees from the axis of a second homogenous telecentric illuminator. This can allow S-polarized light to be detected by the 2D digital image detector. The computer-implemented method can command the second homogenous illuminator to activate its light emitter that emits light above the maximum polarizing wavelength so that the emitted light is not polarized by the polarizing filters, and command the 2D digital image detector to take a 2D digital image of the certified gloss calibration tile/object. The computer-implemented method can store the values at each pixel in the 2D digital image of the certified gloss calibration tile/object as the base gloss value at that pixel.

Some embodiments can include a computer-implemented method of color and shade detection. In some embodiments, the method of color and shade detection can include generating and storing a current white tile 2D digital image using the 2D digital image detector. In some embodiments, generating the current white tile 2D digital image can include taking an image of a white tile at each light emitter light wavelength to obtain a current white tile image at each light emitter light wavelength.

To generate the current white tile image, the computer-implemented method can in some embodiments signal the PLC to perform one or more operations using actuators and motors after the white tile is placed on the object platform: open the door/flap, move the object platform with the white tile into the enclosure to the imaging position (within range of the 2D digital image detector plane), close the door, activate all light emitters in each homogenous telecentric illuminator to bring the light emitters to an operating temperature, activate cooling system for the light emitters as necessary to bring them to an operating temperature, deactivate all light emitters, activate a corresponding set of light emitters at a particular light wavelength and take and store a 2D digital image at the particular light wavelength, then deactivate the corresponding set of light emitters, then repeat for all the corresponding set of light emitters at various wavelengths. In some embodiments the total number of 2D digital images and light emitter light wavelengths is seven.

In some embodiments, the computer-implemented method of color and shade detection can include determining a time-variant scalar for each pixel in the white tile image as the difference between the current white tile image and a previous white tile image at each light emitter light wavelength (or filtered light wavelength, in the case of a filter wheel). In the case of a first operation, the previous white tile image can be the base-line white tile image. In some embodiments the difference is measured at each pixel. In some embodiments the time scalar accounts for environmental variance between scans.

In some embodiments, the computer-implemented method of color and shade detection can include determining a flat field scalar in the white tile image as one or more central pixel intensities in the white tile image. In some embodiments the central pixels can include a user-configurable number of pixels. In some embodiments the central pixels can include the central nine pixels. In some embodiments the central pixel intensity = average pixel intensity of the central pixels. In some embodiments the flat field scalar = (average center pixel intensity)/(pixel intensity at x,y). The flat field scalar accounts for vignetting whereby pixels in the center of the image are brighter than pixels on a periphery of the image.

In some embodiments, the computer-implemented method of color and shade detection can include determining the color and shade of a physical object. In some embodiments, determining the color and shade of a physical object can include loading the physical object into an enclosure of a color and shade detection device, receiving a 3D digital model of the physical object, performing a 3D digital scan of the physical object using a 3D digital scanner, registering the 3D digital scan with the 3D digital model, and generating a 2D digital image of the physical object using the 2D digital image detector at each light emitter light wavelength (or filtered light wavelength) in the embodiment of the filter wheel.

In some embodiments, the computer-implemented method communicating with the PLC can use actuators and motors after the physical object is placed on the object platform to perform the following operations: open the door/flap, move the object platform with the physical object into the enclosure within range of the 3D digital scanner and the 2D digital image detector, and close the door. The computer-implemented method can receive a 3D digital model of the physical object. In some embodiments the physical object has been generated from an existing 3D digital model. In some embodiments the 3D digital model has been generated from a prior 3D digital scan of the physical object. The computer-implemented method can then 3D scan the physical object using the 3D digital scanner to generate a 3D digital scan of the physical object. This can be performed by the computer-implemented method signaling the PLC to move the object platform with the physical object into scanning range of the 3D digital scanner, and activating one or more motors to rotate the object platform and perform 3D scanning with the 3D digital scanner. The physical object can be rotated while 3D scanning to generate a 3D digital scan of the physical object. In some embodiments the physical object is rotated 360 degrees. The computer-implemented method can register the 3D digital scan with the 3D digital model. In some embodiments registration is performed by iterative closest point registration as is known in the art. Iterative closest point registration can include: (1) Match each point in the source 3D digital model with the closest point in the reference 3D digital scan (or a selected set). (2) Estimate the combination of rotation and translation using a root mean square point to point distance metric minimization technique which will best align each 3D digital model point to its match found in the previous step. This step may also involve weighting points and rejecting outliers prior to alignment. (3) Transform the source points using the obtained transformation. (4) Iterate--re-associate the points

In some embodiments registration is performed using registration techniques known in the art.

In some embodiments, the computer-implemented method can identify a pre-marked best color determination region from the 3D digital model. In some embodiments, the best color determination region has been marked manually in the 3D digital model by a technician, dentist, or other user. In some embodiments the best color determination region is marked automatically in the 3D digital model using a trained neural network. Next, the computer-implemented method can signal the PLC to arrange the physical object to align the best color detection region of the physical object to be in a plane of detection of the 2D digital image detector. This can include, for example, arranging the physical object so that a tangent to the best color detection region is perpendicular to a 2D digital image detector axis. In some embodiments the physical object is arranged (rotated and/or translated) so that the best color determination region normal is substantially perpendicular to a face of the 2D digital image detector. In some embodiments arranging the physical object can include rotating the physical object based on the coordinate system transform matrix. In some embodiments arranging the physical object can include translating (moving) the physical object based on the coordinate system transform matrix. Next, the computer-implemented method can warm up light emitters to reach the operating temperature. In some embodiments, warming up the light emitters can include activate all light emitters until the operating temperature is reached. In some embodiments, a cooling system can be used to lower the light emitter temperature as necessary. In some embodiments, the computer-implemented can take a 2D digital image with the 2D digital image detector at each particular light emitter light wavelength, or filtered light wavelength, in the alternative embodiment of the filter wheel. In some embodiments the number of particular light emitter light wavelengths is seven light emitter light wavelengths or filtered light wavelength, in the alternative embodiment of the filter wheel, and the number of 2D digital images is seven 2D digital images, one at each particular light emitter light wavelength, or filtered light wavelength, in the alternative embodiment of the filter wheel. In some embodiments, taking the 2D digital image of the physical object can include illuminating the physical object with a particular light emitter light wavelength by activating a corresponding set of light emitters of the particular wavelength, and recording the 2D digital image. In some embodiments, taking the 2D digital images of the physical object at the particular light wavelengths can include activating a corresponding set of light emitters at a particular light wavelength, taking and storing a 2D digital image at the particular light wavelength, then deactivate the corresponding set of light emitters, then repeating for all the corresponding set of light emitters at various wavelengths. In some embodiments sequentially illuminating can include: activating a first corresponding set of emitters in the light sources to emit light at a first light emitter light wavelength, detecting using the 2D digital image detector and digitally saving a first detected image, deactivating the first corresponding set of light emitters, activating a second corresponding set of light emitters in the light sources to emit light at a second light emitter light wavelength, detecting using the 2D digital image detector and digitally saving a second detected image, deactivating the second corresponding set of light emitters, and so on, repeating until a 2D digital image has been recorded at each particular light emitter wavelength.

In the alternative embodiment of a filter wheel, the light source in each homogenous telecentric illuminator generates white light, which is then filtered by the filter wheel to transmit specific unique wavelengths at each rotational position of the filter wheel. In some embodiments, the computer-implemented method can activate the homogenous telecentric illuminators to emit white light, and take an image at each rotational position of the filter wheel.

In some embodiments, the computer-implemented method can also take a noise 2D digital image with all light emitters off as a final image. In some embodiments, the computer-implemented method can subtract the noise 2D digital image from all other 2D digital images. The noise 2D digital image accounts for noise of dark light emitters and any environment noise. The noise can include ambient light wavelengths. The noise 2D digital image can thus account for dark noise of 2D digital image detector as well as ambient light noise. In some embodiments, the computer-implemented method can apply the time-variant scalar to each pixel in each of the 2D digital images. In some embodiments, the computer-implemented method can apply the flat field scalar to each pixel in each of the 2D digital images.

In some embodiments, the computer-implemented method can also detect LED response variation. The computer-implemented method can compare a current flux detected using the flux detector to a previous flux detected. In some embodiments, the computer-implemented method can generate a scalar to account for variation. Alternatively, the computer-implemented method can generate an error message to require recalibration.

In some embodiments, the computer-implemented method can determine the spectral response of the best color determining region from the one or more 2D digital images. Because the 3D digital model with the marked location for the best color determining region is registered with the 3D digital scanner, and because 2D digital image detector pixels and the 3D digital scanner coordinates are both calibrated to machine coordinates and have a common center, the computer-implemented method can determine the best color determining pixel location/region in the 2D digital images corresponding to the selected best color determining region marked in the 3D digital model. Accordingly, the computer-implemented method can determine the best color determining pixel(s) in the 2D digital images from the best color determining region selected in the 3D digital model of the physical object. In some embodiments, where the best color determining region in the 3D digital model of the physical object is a point, the computer-implemented method determines a single pixel in each 2D digital image that corresponds to the selected point.

In some embodiments the color determining pixel in the 2D digital images can be expanded by a user-configurable number of pixels around the best color determining pixel. In some embodiments the number of pixels around the selected point can include 100 pixels, for example.

In some embodiments, the computer-implemented method can determine the spectral response for the color determining pixel(s). The spectral response of each color determining pixel can be determined by applying the CCM to the measured intensity of light detected at the light emitter light wavelengths, or filtered light wavelengths, in the alternative embodiment of the filter wheel, at that pixel. In some embodiments, the computer-implemented method can determine the spectral response of the color determining pixel(s) by performing matrix multiplication as follows: MMULT(CCM, ColorDeterminingPixels) to get the spectral response of the color determining pixels. Since the CCM was originally determined from a starting calibration wavelength to a final calibration wavelength at calibration wavelength intervals, applying the CCM to the light emitter light wavelengths, or filtered light wavelengths, in the alternative embodiment of the filter wheel gets the spectral response of each color determining pixel from the same starting calibration wavelength to the final calibration wavelength, spaced apart by the calibration wavelength interval. For example, if the starting calibration wavelength was 380 nm and the final calibration wavelength was 750 nm, with the calibration wavelength interval of 5 nm, then the first value of the spectral response for a pixel is the intensity (or reflectance) at 380 nm, the second intensity or reflectance value in the spectral response for the same pixel is the intensity or reflectance at 385 nm, etc. until 750 nm.

In some embodiments, the computer-implemented method can first perform flat field and white tile correction on the color determining pixel(s) as discussed previously to provide corrected color determining pixel(s), then apply the CCM to get the spectral response. In such an embodiment, the computer-implemented method can determine the spectral values of the corrected color determining pixel(s) by performing matrix multiplication as follows: MMULT(CCM, CorrectedColorDeterminingPixels).

In some embodiments, the computer-implemented method can use the spectral response at each pixel to determine absolute color as x,y,z based on X,Y,Z color functions known in the art and provided by CIE. The spectral response at each pixel is intensities or reflectances for multiple wavelengths at each pixel starting at the starting calibration wavelength and ending at the final calibration wavelength at the calibration wavelength interval. CIE can provide a table to map each wavelength of light in the spectral response to a value of X,Y,Z. By providing the starting calibration wavelength and the final calibration wavelength along with the calibration wavelength interval, a wavelength to x,y,z mapping can be obtained for the spectral response (across multiple wavelengths) at each pixel. Several different mapping standards exist and are known in the art. Examples of some standards mapping wavelengths to X,Y,Z absolute color values can include, for example those known in the art, such as 2-deg XYZ CMFs transformed from the CIE (2006) 2-deg LMS cone fundamentals, 10-deg XYZ CMFs transformed from the CIE (2006) 10-deg LMS cone fundamentals, CIE 1931 2-deg, XYZ CMFs, CIE 1931 2-deg, XYZ CMFs modified by Judd (1951), CIE 1931 2-deg, XYZ CMFs modified by Judd (1951) and Vos (1978), and CIE 1964 10-deg, XYZ CMFs. Any of these provided mappings can be used.

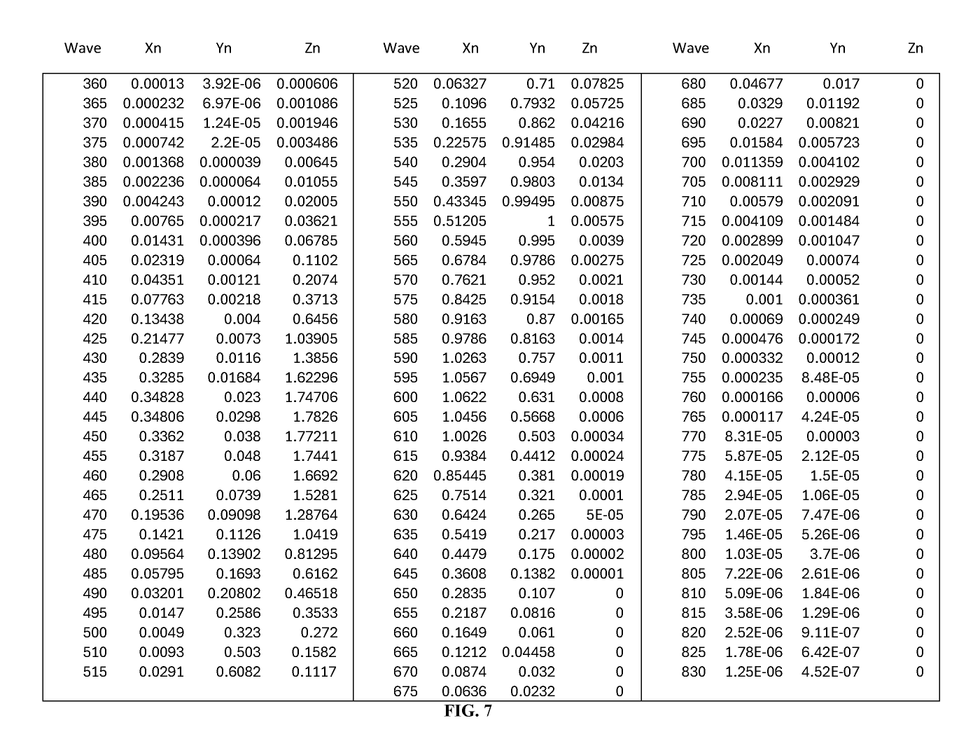

FIG. 7 illustrates one example of the CIE 1931 2-deg, XYZ CMFs mapping between spectral responses and X, Y, Z value, with a wavelength interval of 5 nm, a starting wavelength of 360 nm (columns labeled “Wave”) and a final wavelength of 830 nm. In some embodiments, the starting calibration wavelength and the final calibration wavelength should fall within the starting wavelength and final wavelength range, and the calibration wavelength interval and the wavelength interval provide in the table should be the same when mapping between spectral responses and X,Y,Z.

In some embodiments, the computer-implemented method can determine the absolute color for each pixel by performing the following:

For each pixel, multiply the intensity value at the particular wavelength by the Xn, Yn, and Zn values appearing in the mapping table for that same wavelength to obtain the corresponding Xn`, Yn’, and Zn’ for that wavelength. Do this for all wavelengths in the spectral response of each pixel. Next, for each pixel, sum or add all of the Xn’ values for all of the wavelengths together to obtain X, sum all of the Yn’ across all wavelengths to obtain Y, and sum all of the Zn’ across all wavelengths to obtain Z. Next, for each pixel, determine x as x=X/(X+Y+Z), y = Y/(X+Y+Z), and z= Z/(X+Y+Z). Accordingly, each color determining pixel will have a single x,y,z that represents the absolute color for the color determining pixel.

In some embodiments the color is specified by LAB, a color naming scheme known in the art. In some embodiments L refers to lightness. In some embodiments L ranges on a scale from 0 to 100, In some embodiments 0 is pure black, and 100 is pure white. In some embodiments A refers a red-green range. In some embodiments a negative A value is green and a positive A value is red, 0 is neutral. In some embodiments B refers to a blue-yellow range. In some embodiments a negative B value is blue and a positive B value is yellow, 0 is neutral. In some embodiments, a LAB color for each color determining pixel can be obtained from the absolute colors x,y,z for each pixel using techniques known in the art.

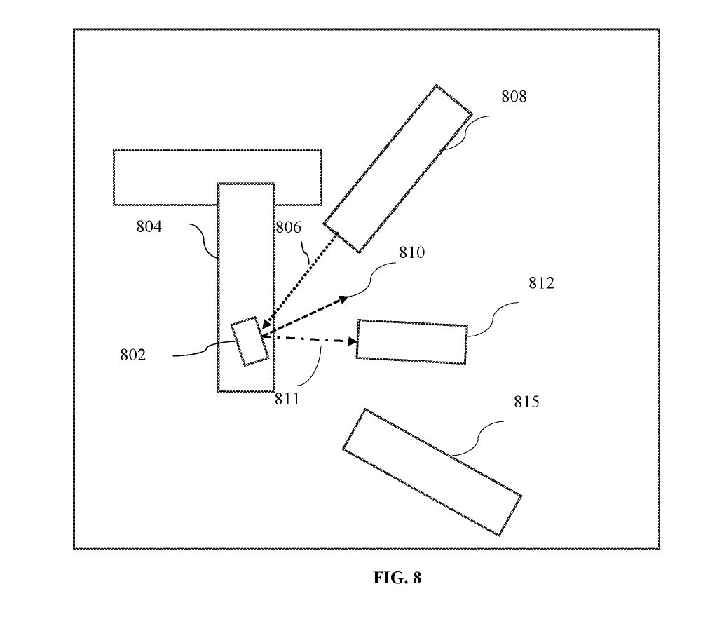

In some embodiments, the computer-implemented method can include determining glossiness of at least a portion of the physical object at a pixel level. In some embodiments, the computer-implemented method can determine glossiness by turning off the light sources in a first homogenous telecentric illuminator and commanding the object platform to rotate the physical object by same angle used for glossiness calibration. In some embodiments the computer-implemented method can rotate the physical object so that a normal to the best color determination region makes the same angle as the gloss calibration angle. For example, in some embodiments, the angle can be 12.5 degrees (see FIG. 8). In some embodiments, the computer-implemented method rotates the physical object on the rotatable object platform such that an angle between a normal to the physical object surface and second homogenous telecentric illuminator is the same as the angle between the normal to the physical object surface and the 2D digital image detector. In some embodiments, the physical object surface can be the best color determination region. This can allow S-polarized light to be detected by the 2D digital image detector. The computer-implemented method can command the second homogenous illuminator to activate its light emitter that emits light above at or above the maximum polarizing wavelength so that the emitted light is not polarized by the polarizing filters, and command the 2D digital image detector to take a 2D digital image of the physical object. The computer-implemented method can then determine glossiness by dividing (at each pixel in the 2D digital image) the detected readings at each pixel by the base glossiness detected during calibration. For example, if a certified 100 percent reflective tile during calibration registered 3000 at each pixel in its 2D digital image and the object 2D digital image registers 2500 at each pixel during operation, then each pixel’s glossiness would be 2500/3000, or approximately 83 percent glossy. In some embodiments, the glossiness can be determined for the best color determining region, which can be the same region as the color determining pixels in the 2D digital image of the physical object.

FIG. 8 illustrates an example of a configuration for determining glossiness in some embodiments. The physical object 802 on an object platform connected to the physical object platform arm 804 is rotated such the angle between a normal 810 to the surface of the physical object and a beam axis 806 of the homogenous telecentric illuminator 808 is the same as the angle between the normal 810 and a normal 811 to the planar surface of the 2D digital image detector 812. The computer-implemented method can activate the light emitter in the homogenous telecentric illuminator 808 that emits a light wavelength above the maximum polarizing wavelength and the 2D digital image detector 812 can take a 2D digital image. The computer-implemented method can then determine glossiness per pixel of the desired area by dividing the detected intensity by the base glossiness. The homogenous telecentric illuminator 815 is not activated or used during determination of glossiness.

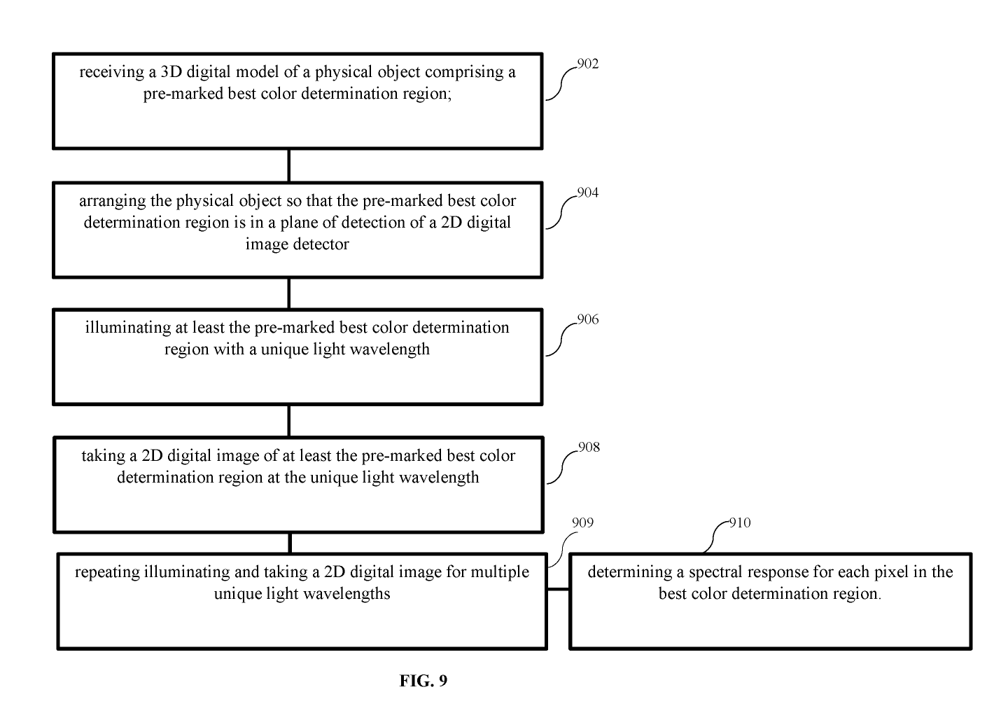

FIG. 9 shows a flow diagram of some embodiments of the present disclosure. The flow can include receiving a 3D digital model of a physical object comprising a pre-marked best color determination region 902, arranging the physical object so that the pre-marked best color determination region is in a plane of detection of a 2D digital image detector 904, illuminating the at least the pre-marked best color determination region with light at one or more unique light wavelengths 906, taking a 2D digital image of at least the pre-marked best color determination region at the unique light wavelength 908, repeating illuminating and taking a 2D digital image for multiple unique light wavelengths 909, and determining a spectral response for each pixel in the best color determination region 910. In some embodiments, for quality control (“QC”), the computer-implemented method can determine whether the shade is off in terms of hue or lightness.

One or more advantages of one or more features can include, for example, quantitative determination of color and shade. One or more advantages of one or more features can include, for example, measurement of color and shade on uneven surfaces. One or more advantages of one or more features can include, for example, measurement of color and shade on shiny surfaces, including those exhibiting translucency effects. One or more advantages of one or more features can include, for example, accommodating for the wall thickness of an object. One or more advantages of one or more features can include, for example, keeping the sensor/camera axis parallel to the symmetry plane of the light sources in a mass production environment. One or more advantages of one or more features can include, for example, maintaining homogeneity of the light on the physical object by keeping the distance between the object/dental restoration surface and light source constant. One or more advantages of one or more features can include, for example, accounting for fluorescence effects of the physical object by filtering the reflected light. One or more advantages can include accounting for LED flux change with respect to temperature and/or the flux change caused by LED degradation. One or more advantages of one or more features can include, for example, providing volumetric surface color measurement.

In some embodiments, the use of homogenous telecentric illumination can advantageously provide the same luminous flux over the target for variable distance (+/-5mm) to illuminate uneven restoration surfaces consistently. In some embodiments, with homogenous telecentric illumination, almost the same light intensity can be achieved on every point on the surface even if the surface is not perfectly flat or smooth. Furthermore, in some embodiments, the cross polarization between the light source and the camera can be achieved using polarization filters. This can eliminate the specular highlights which can affect measurement accuracy in some embodiments. The polarization can be limited to the visible spectrum and hence the glossiness of the surface can be measured using the wavelengths outside of the visible spectrum in some embodiments. This information can then be used to correct for the lightness of the surface reflectance in some embodiments. In some embodiments, restorations can be held using two different opaque fixtures (black and white OR any 2 shades of grey) from a cavity of the physical object. The relative translucency can be measured or it can be quantified by taking two separate measurements in some embodiments. For spectrometric measurement, the target surface normal and the symmetry plane relation can be corrected and maintained using 3D digital scanner by registering and orienting the restoration to the required position in some embodiments. Since the object/dental restoration is held on a fixture which is articulated by the motion actuators and is localized using 3D digital scanners, any point on the object/dental restoration can be chosen using the geometric or design software for the measurement in some embodiments. With this, front sides and back of the object/dental restoration can be measured by keeping the target surface on the object/dental restoration perpendicular to the camera axis and keeping the distance between the surface and the light source. In some embodiments, the computer-implemented method can use the translucency effect to color-correct the best color determination region if it exhibits different translucency due to change in thickness.

Some embodiments include a processing system for color and shade detection: a processor, a computer-readable storage medium including instructions executable by the processor to perform steps including one or more features described in the present disclosure.

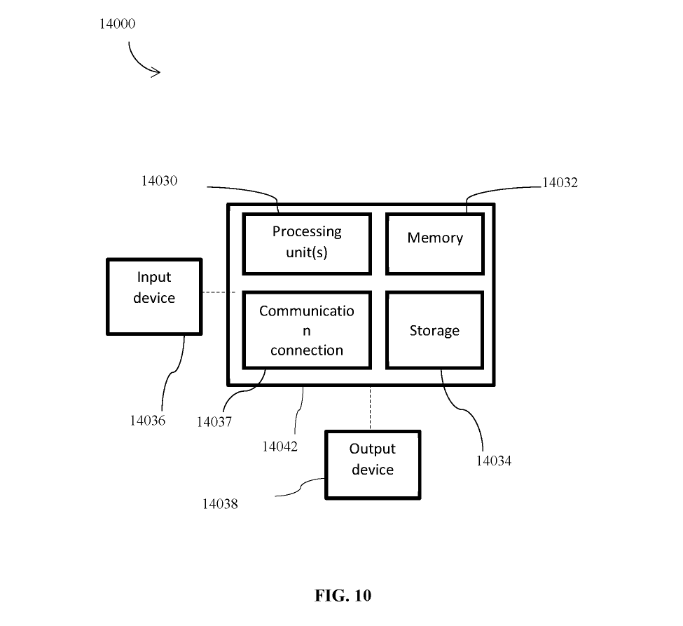

FIG. 10 illustrates a processing system 14000 In some embodiments,. The system 14000 can include a processor 14030, computer-readable storage medium 14034 having instructions executable by the processor to perform one or more steps described in the present disclosure.

In some embodiments, one or more features can be initiated by a user, for example. In some embodiments, one or more features can be performed by a user using an input device while viewing the digital model on a display, for example. In some embodiments, the computer-implemented method can allow the input device to manipulate the digital model displayed on the display. For example, In some embodiments, the computer-implemented method can rotate, zoom, move, and/or otherwise manipulate the digital model in any way as is known in the art. In some embodiments, one or more features can be performed by a user using the input device. In some embodiments, one or more features can be initiated, for example, using techniques known in the art, such as a user selecting another button.

In some embodiments, the computer-implemented method can display a 3D digital model and/or a 2D digital image on a display and receive input from an input device such as a mouse or touch screen on the display for example. For example, the computer-implemented method can receive one or more points selected. The computer-implemented method can, upon receiving an initiation command, perform color and shade detection using one or more features described in the present disclosure. The computer-implemented method can, upon receiving manipulation commands, rotate, zoom, move, and/or otherwise manipulate the digital model in any way as is known in the art.

One or more of the features disclosed herein can be performed and/or attained automatically, without manual or user intervention. One or more of the features disclosed herein can be performed by a computer-implemented method. The features—including but not limited to any methods and systems—disclosed may be implemented in computing systems. For example, the computing environment 14042 used to perform these functions can be any of a variety of computing devices (e.g., desktop computer, laptop computer, server computer, tablet computer, gaming system, mobile device, programmable automation controller, video card, etc.) that can be incorporated into a computing system comprising one or more computing devices. In some embodiments, the computing system may be a cloud-based computing system.

For example, a computing environment 14042 may include one or more processing units 14030 and memory 14032. The processing units execute computer-executable instructions. A processing unit 14030 can be a central processing unit (CPU), a processor in an application-specific integrated circuit (ASIC), or any other type of processor. In some embodiments, the one or more processing units 14030 can execute multiple computer-executable instructions in parallel, for example. In a multi-processing system, multiple processing units execute computer-executable instructions to increase processing power. For example, a representative computing environment may include a central processing unit as well as a graphics processing unit or co-processing unit. The tangible memory 14032 may be volatile memory (e.g., registers, cache, RAM), non-volatile memory (e.g., ROM, EEPROM, flash memory, etc.), or some combination of the two, accessible by the processing unit(s). The memory stores software implementing one or more innovations described herein, in the form of computer-executable instructions suitable for execution by the processing unit(s).

A computing system may have additional features. For example, In some embodiments, the computing environment includes storage 14034, one or more input devices 14036, one or more output devices 14038, and one or more communication connections 14037. An interconnection mechanism such as a bus, controller, or network, interconnects the components of the computing environment. Typically, operating system software provides an operating environment for other software executing in the computing environment, and coordinates activities of the components of the computing environment.

The tangible storage 14034 may be removable or non-removable, and includes magnetic or optical media such as magnetic disks, magnetic tapes or cassettes, CD-ROMs, DVDs, or any other medium that can be used to store information in a non-transitory way and can be accessed within the computing environment. The storage 14034 stores instructions for the software implementing one or more innovations described herein.

The input device(s) may be, for example: a touch input device, such as a keyboard, mouse, pen, or trackball; a voice input device; a scanning device; any of various sensors; another device that provides input to the computing environment; or combinations thereof. For video encoding, the input device(s) may be a camera, video card, TV tuner card, or similar device that accepts video input in analog or digital form, or a CD-ROM or CD-RW that reads video samples into the computing environment. The output device(s) may be a display, printer, speaker, CD-writer, or another device that provides output from the computing environment.

The communication connection(s) enable communication over a communication medium to another computing entity. The communication medium conveys information, such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

Any of the disclosed methods can be implemented as computer-executable instructions stored on one or more computer-readable storage media 14034 (e.g., one or more optical media discs, volatile memory components (such as DRAM or SRAM), or nonvolatile memory components (such as flash memory or hard drives)) and executed on a computer (e.g., any commercially available computer, including smart phones, other mobile devices that include computing hardware, or programmable automation controllers) (e.g., the computer-executable instructions cause one or more processors of a computer system to perform the method). The term computer-readable storage media does not include communication connections, such as signals and carrier waves. Any of the computer-executable instructions for implementing the disclosed techniques as well as any data created and used during implementation of the disclosed embodiments can be stored on one or more computer-readable storage media 14034. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, Python, JavaScript, Adobe Flash, or any other suitable programming language. Likewise, the disclosed technology is not limited to any particular computer or type of hardware. Certain details of suitable computers and hardware are well known and need not be set forth in detail in this disclosure.

It should also be well understood that any functionality described herein can be performed, at least in part, by one or more hardware logic components, instead of software. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

In view of the many possible embodiments to which the principles of the disclosure may be applied, it should be recognized that the illustrated embodiments are only examples and should not be taken as limiting the scope of the disclosure.

What is claimed is:

1. A device for detecting color and shade, comprising:
one or more homogenous telecentric illuminators;
a 3 dimensional scanner (3D digital scanner) arranged to scan the physical object and provide a 3D scan of the physical object;
a 2D digital image detector arranged to generate a 2D digital image of the physical object; and
an object platform arm arranged to translate and rotate the physical object.

2. The device of claim 1, wherein each of the one or more homogenous telecentric illuminators comprises a light source and a bi-telecentric lens.

3. The device of claim 2, wherein the light source comprises one or more light emitters emitting light at a unique light wavelength.

4. The device of claim 2, wherein each of the one or more homogenous telecentric illuminators comprise a first light guide to receive light emitted from the light source and transmit a homogenous and diffused light.

5. The device of claim 4, further comprising a second light guide that receives the homogenous and defused light and transmits further homogenized and diffused light to the bi-telecentric lens.

6. The device of claim 1, further comprising a flux detector attached to an output lens of the bi-telecentric lens of each homogenous telecentric illuminator.

7. The device of claim 1, further comprising a polarizing lens attached to an output lens of the bi-telecentric lens of each homogenous telecentric illuminator to output polarized light.

8. The device of claim 1, further comprising an enclosure to block outside light during operation.

9. A computer-implemented method of calibrating a device for color and shade detection, comprising:
determining a 3D digital scanner to machine coordinate system transform;
determining a 2D digital image detector to machine coordinate transform; and
determining a color calibration matrix.

10. The method of claim 9, wherein determining the color calibration matrix comprises using one or more certified color calibration tiles.

11. The method of claim 10, wherein determining the color calibration matrix comprises taking a 2D digital image of each certified tile at a particular unique light wavelength to generate a recorded tile pixel value.

12. The method of claim 9, further comprising determining a base glossiness.

13. The method of claim 12, wherein determining base glossiness comprises detecting a 2D image of a physical object illuminated by light of a wavelength greater than a maximum polarizing wavelength.

14. A computer-implemented method of determining color and shade, comprising:
receiving a 3D digital model of a physical object comprising a pre-marked best color determination region;
arranging the physical object so that the pre-marked best color determination region is in a plane of detection of a 2D digital image detector;
illuminating at least the pre-marked best color determination region with a unique light wavelength;
taking a 2D digital image of at least the pre-marked best color determination region at the unique light wavelength;
repeating illuminating and taking a 2D digital image for multiple unique light wavelengths; and
determining a spectral response for each pixel in the best color determination pixel region in the 2D digital image.

15. The method of claim 14, further comprising determining an absolute color for each pixel in the best color determination region.

16. The method of claim 14, further comprising determining a current white tile image.

17. The method of claim 14, wherein illuminating the physical object comprises using one or more homogenous telecentric illuminators.

18. The method of claim 17, wherein each of the one or more homogenous telecentric illuminators comprises a light source comprising one or more light emitters.

19. The method of claim 18, wherein each light emitter of the one or more light emitters emits light at a unique wavelength.

20. The method of claim 18, wherein each of the one or more homogenous telecentric illuminators comprises a polarizer to polarize emitted light.

21. The method of claim 18, further comprising heating the light emitters to an operating temperature.
